(19) United States
(12) Patent Application Publication
(10) Pub. No.: US 2009/0150139 A1
(43) Pub. Date: Jun. 11, 2009

(54) METHOD AND APPARATUS FOR TRANSLATING A SPEECH

(75) Inventors: Li JIANFENG, Beijing (CN); Wang Haifeng, Beijing (CN); Wu Hua, Beijing (CN)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/330,715

(22) Filed: Dec. 9, 2008

(30) Foreign Application Priority Data
Dec. 10, 2007 (CN) 200710193374.X

(51) Int. Cl. G06F 17/28; G06F 17/27; G10L 15/26

(52) U.S. Cl. 704/4; 704/9; 704/235; 704/E15.043

(57) ABSTRACT

There is provided a method for translating a speech, includes recognizing the speech into a text which includes a long sentence containing a plurality of simple sentences, segmenting the long sentence into the simple sentences, and translating each simple sentence into a sentence of a target language. A long sentence segmentation module is inserted between the speech recognition module and the machine translation module in the method, wherein the long sentence in the text recognized can be split into several simple and complete sentences. In this way, difficulties in translation are relieved, and translation quality is improved. Further, there is also provided a user interface which allows the user to modify the segmentation results conveniently. The modifying operations of the user are recorded to update the segmentation model online to improve the effect of the automatic segmentation step by step.

### CROSS-REFERENCE TO RELATED APPLICATIONS

This application is based upon and claims the benefit of priority from prior Chinese Patent Application No. 200710193374.X, filed Dec. 10, 2007, the entire contents of which are incorporated herein by reference.

### BACKGROUND OF THE INVENTION

1. Field of the Invention

The present invention relates to information processing technology, specifically to the technology of translating a speech.

2. Description of the Related Art

Generally, when translating a speech, first it is needed to recognize the speech into a text by using a speech recognition technique, and then the text is translated by using a machine translation technique.

The detail description of the speech recognition technique can be seen in the article “Fundamentals of Speech Recognition” written by L. Rabiner and Biing-Hwang Juang, Prentice Hall, 1993 (referred to article 1 hereafter), all of which are incorporated herein by reference.

Machine translation techniques can be categorized into three classes: rule-based translation, example-based translation, and statistical translation. These techniques have been successfully applied for translating written texts.

The detail description of the machine translation technique can be seen in the article “Retrospect and prospect in computer-based translation” written by Hutchins, John, 1999, In Proc. of Machine Translation Summit VII, pages 30-34 (referred to article 2 hereafter), all of which are incorporated herein by reference.

Generally, natural speech flow is not as fluent as written texts. Some speech phenomena, such as pauses, repetitions and repairs, occur now and then. In this case, the speech recognition module is not able to recognize one complete simple sentence. Instead, the speech recognition module combines a plurality of simple sentences or sentence fragments of a user into a long sentence and outputs it to the machine translation module. Since the long sentence output by the speech recognition module contains a plurality of simple sentences, it's very difficult for the machine translation module to translate it.

Therefore, there is a need to provide a method for segmenting the long sentence recognized by the speech recognition module into a plurality of simple sentences.

Moreover, a few methods for automatically segmenting long sentences have been proposed in the prior art. But the automatic segmentation module of the prior art is trained in advance and it cannot be automatically updated according to user's practical requirements while being used in line. Therefore, the phenomena, such as segmentation errors, occur seriously.

Therefore, there is a need to provide a segmentation method for reducing segmentation errors efficiently and adapting for user's requirements.

### BRIEF SUMMARY OF THE INVENTION

In order to solve the above-mentioned problems in the prior technology, the present invention provides a method and an apparatus for translating a speech.

According to an aspect of the present invention, there is provided a method for translating a speech, comprising: recognizing the speech into a text which includes at least one long sentence containing a plurality of simple sentences; segmenting said at least one long sentence into a plurality of simple sentences; and translating each of said plurality of simple sentences segmented into a sentence of a target language.

According to another aspect of the present invention, there is provided an apparatus for translating a speech, comprising: a speech recognition unit configured to recognize the speech into a text which includes at least one long sentence containing a plurality of simple sentences; a segmentation unit configured to segment said at least one long sentence into a plurality of simple sentences; and a translation unit configured to translate each of said plurality of simple sentences segmented by the segmentation unit into a sentence of a target language.

### BRIEF DESCRIPTION OF THE SEVERAL VIEWS OF THE DRAWING

It is believed that through following detailed description of the embodiments of the present invention, taken in conjunction with the drawings, above-mentioned features, advantages, and objectives will be better understood.

FIG. 1 is a flowchart showing a method for translating a speech according to an embodiment of the present invention;

FIG. 2 is a detail flowchart showing a method for translating a speech according to the embodiment of the present invention;

FIG. 3 is a detail schematic view showing a process of training a segmentation model;

FIG. 4 is a detail schematic view showing a process of searching an optimal segmentation path;

FIG. 5 is a detail schematic view showing a process of modifying and a process of updating a segmentation model; and

FIG. 6 is a block diagram showing an apparatus for translating a speech according to another embodiment of the present invention.

### DETAILED DESCRIPTION OF THE INVENTION

Next, a detailed description of the preferred embodiments of the present invention will be given in conjunction with the drawings.

Method for Translating a Speech

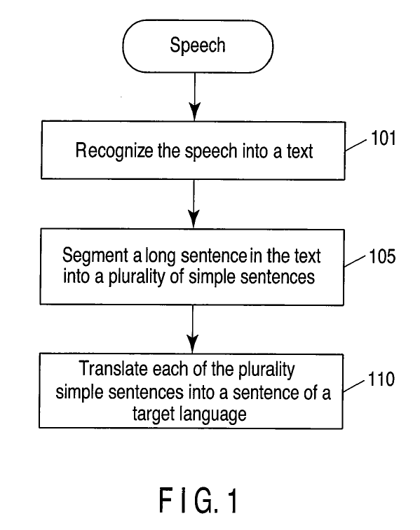

FIG. 1 is a flowchart showing a method for translating a speech according to an embodiment of the present invention. Next, the embodiment will be described in conjunction with the drawing.

As shown in FIG. 1, first in step 101, a speech spoken by a user is recognized into a text. In the embodiment, any speech recognition technique known by those skilled in the art or developed in the future, such as the speech recognition technique disclosed in the above article 1, can be used, and the present invention has no limitation on this as long as the speech input can be recognized into a text.

In the embodiment, the text recognized in step 101 includes one or more long sentences containing a plurality of simple sentences. These long sentences are composed of a plurality of simple and complete sentences, such as the following sentence:

That's very kind of you but I don't think I will I'm driving.

which is composed of the following 3 simple sentences:

That's very kind of you.

But I don't think I will.

I'm driving.

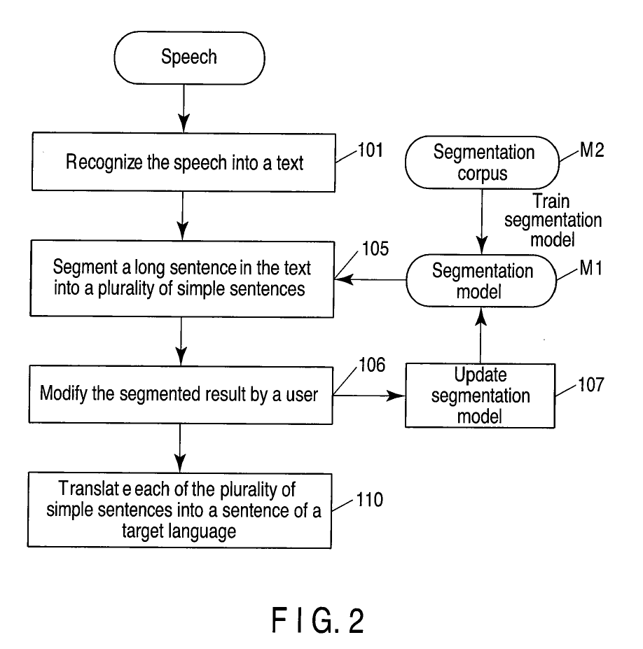

Next, in step 105, one or more long sentences in the text recognized in step 101 are segmented into a plurality of simple sentences. The process of segmenting a long sentence into a plurality of simple sentences of the embodiment will be described in detail by reference of FIG. 2 in follows.

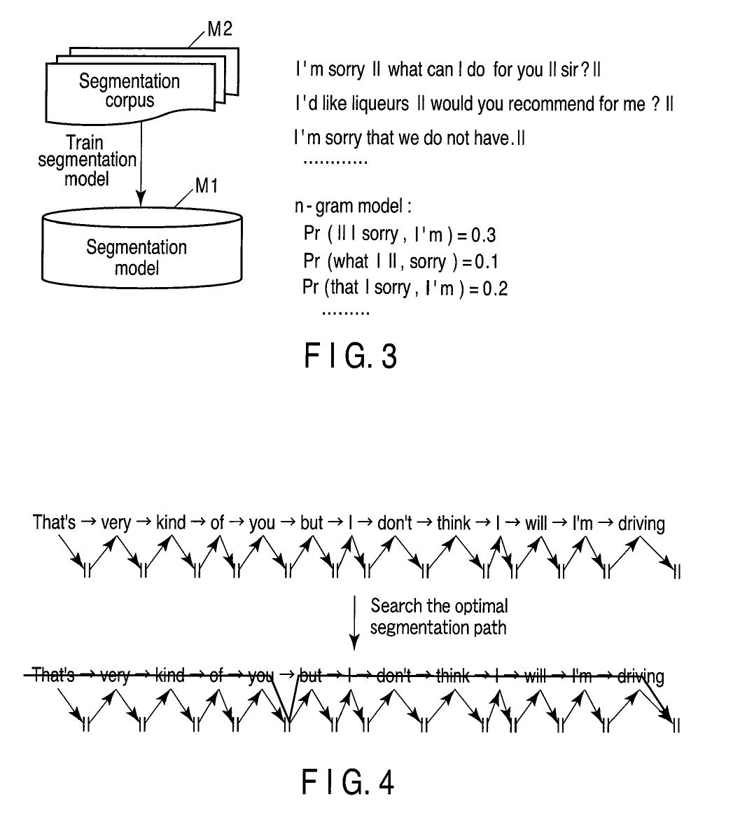

FIG. 2 is a detail flowchart showing a method for translating a speech according to the embodiment of the present invention. As shown in FIG. 2, in step 205, the long sentence in the text recognized in step 101 is segmented into a plurality of simple sentences by using a segmentation model M1. The segmentation model M1 will be described in detail firstly by reference of FIG. 3 in follows.

FIG. 3 is a detail schematic view showing a process of training a segmentation model. In the embodiment, the segmentation model M1 is trained by using a segmentation corpus M2. As show in FIG. 3, the segmentation corpus M2 includes a text which is segmented correctly. The segmentation model M1 is similar to an n-gram language model except a mark “∥” for a sentence boundary is treated as a common word in the model. In the segmentation model M1 trained, there are included a plurality of n-grams and lower order grams and their probabilities. Moreover, the process of training the segmentation model M1 is similar to that of the n-gram language model. It should be understood that the segmentation model M1 used in the embodiment can be any segmentation model known by those skilled in the art, and the present invention has no limitation on this as long as the long sentence in the text recognized in step 101 can be segmented into a plurality of simple sentences by using the segmentation model.

The process of segmenting the long sentence by using the segmentation model M1 in step 105 of the embodiment will be described in detail by reference of FIG. 4 in follows.

FIG. 4 is a detail schematic view showing a process of searching an optimal segmentation path. First, a segmentation lattice is built for an input sentence. In the segmentation lattice, each word in the sentence to be segmented is registered as one node. Besides, each word boundary is considered to be a potential position of a sentence boundary. A segmentation path comprised of all word nodes and zero or any of one or more candidate sentence boundary nodes is considered as a candidate segmentation path. For example, for the following sentence:

That's very kind of you but I don't think I will I'm driving.

the following candidate segmentation paths can be obtained:

That's very kind of you ∥ but I don't think I will | | I'm driving. ∥

That's ∥ very kind of you but I don't think I will ∥ I'm driving.

That's very kind of you but ∥ I don't think ∥ I will I'm driving. ∥

Then, an optimal segmentation path is searched by using an efficient searching algorithm. In the searching process, a score of each candidate segmentation path is calculated, and this process is similar to the process of Chinese word segmentation. Specifically, for example, the optimal segmentation path is searched by using a Viterbi algorithm. The detail description of the Viterbi algorithm can be seen in the article “Error Bounds for Convolutional Codes and An Asymptotically Optimum Decoding Algorithm” written by A. J. Viterbi, 1967, IEEE Trans. On Information Theory, 13(2), p. 260-269 (referred to article 3 hereafter), all of which are incorporated herein by reference.

Last, a candidate segmentation path with a highest score is selected as the optimal segmentation path. As shown in FIG. 4, the following segmentation path is selected as the optimal segmentation path:

That's very kind of you ∥ but I don't think I will I'm driving. ∥

Return to FIG. 1, after the long sentence in the text recognized in step 101 is segmented into a plurality of simple sentences in step 105, in step 110, each of said plurality of simple sentences is translated into a sentence of a target language. For example, for the above sentence, the following two sentence are needed to be translated respectively:

That's very kind of you ∥

But I don't think I will I'm driving. ∥

In the embodiment, any machine translation techniques such as rule-based translation, example-based translation and statistical translation can be used to translate the above simple sentences. Specifically, for example, the machine translation techniques disclosed in the above article 2 can be used to translate the above simple sentences, and the present invention has no limitation on this as long as the segmented simple sentences can be translated into sentences of a target language.

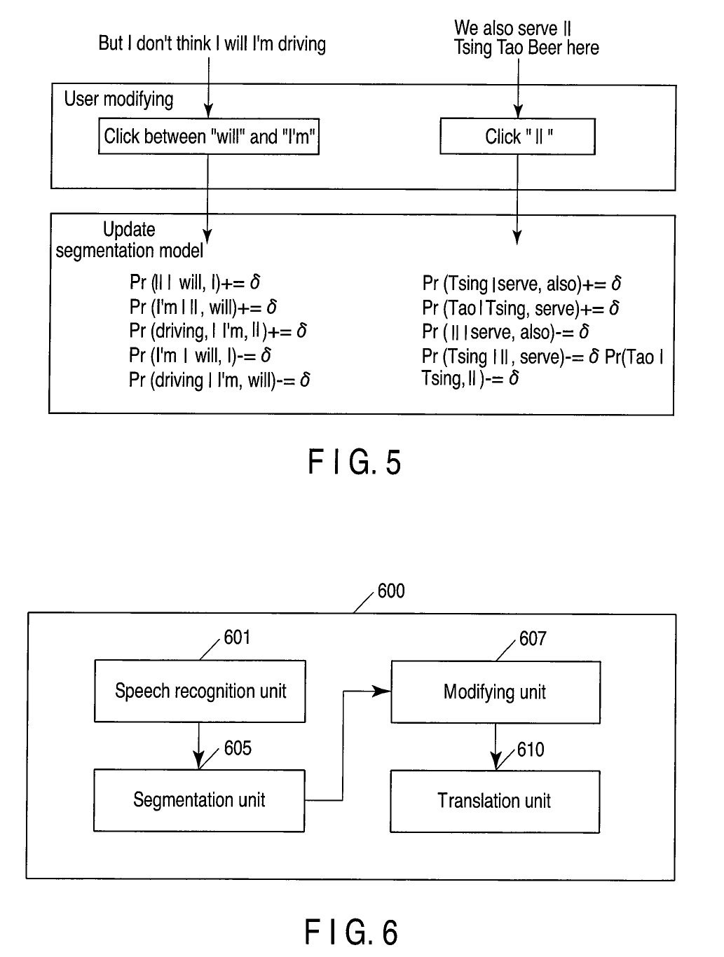

Moreover, in the embodiment, as shown in FIG. 2, after the long sentence in the text recognized in step 101 is segmented into a plurality of simple sentences in step 105, optionally, in step 106, a user is allowed to modify the segmentation result of step 105. The modifying process of the embodiment will be described in detail by reference of FIG. 5 in follows.

FIG. 5 is a detail schematic view showing a process of modifying and a process of updating a segmentation model. As shown in FIG. 5, if there is an error in the segmentation result of step 105, the user can modify the error by a click. For example, there is an error in the following sentence segmented in the segmentation result:

But I don't think I will I'm driving. ∥

which is composed of the following two simple sentences:

But I don't think I will.

I'm driving.

Therefore, in step 106, the user can click a non-recognized segmentation position, that is to click between “will” and “I'm”. Since the position clicked by the user is not a sentence boundary, the position is used as a sentence boundary to segment the sentence. Moreover, if the user clicks a wrong-recognized segmentation position, that is to click a sentence boundary, the sentence boundary is deleted. For example, in the following automatic segmentation result:

We also serve ∥

Tsing Tao Beer here

there is a redundant sentence boundary, therefore there is an error in the segmentation result. At this point, the user can click the redundant sentence boundary to delete the sentence boundary.

Through the modifying process in step 106, the user can modify the segmentation result obtained automatically in step 105 conveniently.

Moreover, after the modifying in step 106, in step 107, the modifying operation performed in step 106 can be used as guide information to update the segmentation model M1 in the method of the embodiment.

Specifically, as shown in FIG. 5, if a sentence boundary “∥” is added between “will” and “I'm”, in step 107, probabilities of new n-grams generated by the modifying operation of the user is increased, and probabilities of n-grams deleted by the modifying operation of the user is decreased.

For example, in FIG. 5, if a sentence boundary “∥” is added between “will” and “I'm” in step 106, in step 107, probabilities of the following new n-grams generated by the modifying operation of the user is increased:

Pr(∥ | I will, I)+=δ, that is to increase the probability of segmenting a sentence after “I will”;

Pr(I'm | ∥, will)+=δ, that is to increase the probability of segmenting a sentence between “will” and “I'm”;

Pr(driving | I'm, ∥)+=δ, that is to increase the probability of segmenting a sentence before “I'm driving”.

On the other hand, in step 107, probabilities of the following n-grams deleted by the modifying operation of the user is decreased:

Pr(I'm | will, I)−=67 , that is to decrease the probability of following “I'm” after “I will”;

Pr(driving | I'm, will)−=δ, that is to decrease the probability of following “driving” after “will” and “I'm”.

Further, if the sentence boundary “∥” is deleted between “serve” and “Tsing” in step 106, in step 107, probabilities of the following new n-grams generated by the modifying operation of the user is increased:

Pr(Tsing | serve, also)+=δ, that is to increase the probability of following “Tsing” after “also server”;

Pr(Tao | Tsing, serve)+=δ, that is to increase the probability of following “Tao” after “server” and “Tsing”.

On the other hand, in step 107, probabilities of the following n-grams deleted by the modifying operation of the user is decreased:

Pr(∥ | serve, also)−=δ, that is to decrease the probability of segmenting a sentence after “also server”;

Pr(Tsing | ∥, serve)−=δ, that is to decrease the probability of segmenting a sentence between “serve” and “Tsing”;

Pr(Tao | Tsing, ∥)−=δ, that is to decrease the probability of segmenting a sentence before “Tsing Tao”.

Through the above description, a step of segmenting a long sentence is inserted between the speech recognition and the machine translation in the method for translating a speech of the embodiment, wherein the long sentence in the text recognized can be split into several simple and complete sentences. In this way, difficulties in translation are relieved, and translation quality is improved.

Further, in order to avoid errors in the automatic segmentation result, there is provided a user interface in the method for translating a speech, which allows the user to modify the segmentation results conveniently. In the same time, the modifying operations of the user are recorded to update the segmentation model online to adapt the personal requirements of the user. The quality of the automatic segmentation can be improved step by step by using the method for translating a speech for a long run, the possibility of error occurrences in the automatic segmentation can be reduced, and the intervention of the user will be less and less.

Apparatus for Translating a Speech

Based on the same concept of the invention, FIG. 6 is a block diagram showing an apparatus for translating a speech according to another embodiment of the present invention. The description of this embodiment will be given below in conjunction with FIG. 6, with a proper omission of the same content as those in the above-mentioned embodiments.

As shown in FIG. 6, the apparatus 600 for translating a speech of the present embodiment comprises: a speech recognition unit 601 configured to recognize said speech into a text which includes at least one long sentence containing a plurality of simple sentences; a segmentation unit 605 configured to segment said at least one long sentence into a plurality of simple sentences; and a translation unit 610 configured to translate each of said plurality of simple sentences segmented by said segmentation unit into a sentence of a target language.

In the embodiment, any speech recognition technique known by those skilled in the art or developed in the future, such as the speech recognition technique disclosed in the above article 1, can be used in the speech recognition unit 601, and the present invention has no limitation on this as long as the speech input can be recognized into a text.

In the embodiment, the text recognized by the speech recognition unit 601 includes one or more long sentences containing a plurality of simple sentences. These long sentences are composed of a plurality of simple and complete sentences, such as the following sentence:

That's very kind of you but I don't think I will I'm driving.

which is composed of the following 3 simple sentences:

That's very kind of you.

But I don't think I will.

I'm driving.

In the embodiment, one or more long sentences in the text recognized by the speech recognition unit 601 are segmented by the segmentation unit 605 into a plurality of simple sentences. The process of the segmentation unit 605 which is configured to segment a long sentence into a plurality of simple sentences of the embodiment will be described in detail in follows.

In the embodiment, the long sentence in the text recognized by the speech recognition unit 601 is segmented by the segmentation unit 605 into a plurality of simple sentences by using a segmentation model M1. The segmentation model M1 will be described in detail firstly by reference of FIG. 3 in follows.

FIG. 3 is a detail schematic view showing a process of training a segmentation model. In the embodiment, the segmentation model M1 is trained by using a segmentation corpus M2. As show in FIG. 3, the segmentation corpus M2 includes a text which is segmented correctly. The segmentation model M1 is similar to an n-gram language model except a mark “∥” for a sentence boundary is treated as a common word in the model. In the segmentation model M1 trained, there are included a plurality of n-grams and lower order grams and their probabilities. Moreover, the process of training the segmentation model M1 is similar to that of the n-gram language model. It should be understood that the segmentation model M1 used in the embodiment can be any segmentation model known by those skilled in the art, and the present invention has no limitation on this as long as the long sentence in the text recognized by the speech recognition unit 601 can be segmented into a plurality of simple sentences by using the segmentation model.

The process of the segmentation unit 605 which is configured to segment the long sentence by using the segmentation model M1 of the embodiment will be described in detail by reference of FIG. 4 in follows. FIG. 4 is a detail schematic view showing a process of searching an optimal segmentation path.

In the embodiment, the segmentation unit 605 includes a candidate segmentation path generating unit configured to generate a plurality of candidate segmentation paths for said at least one long sentence. Specifically, a segmentation lattice is built for an input sentence. In the segmentation lattice, each word in the sentence to be segmented is registered as one node. Besides, each word boundary is considered to be a potential position of a sentence boundary. A segmentation path comprised of all word nodes and zero or any of one or more candidate sentence boundary nodes is considered as a candidate segmentation path. For example, for the following sentence:

That's very kind of you but I don't think I will I'm driving.

the following candidate segmentation paths can be obtained:

That's very kind of you ∥ but I don't think I will I'm driving. ∥

That's ∥ very kind of you but I don't think I will ∥ I'm driving.

That's very kind of you but ∥ I don't think ∥ I will I'm driving. ∥

In the embodiment, the segmentation unit 605 further includes a score calculating unit configured to calculate a score of each of said plurality of candidate segmentation paths by using said segmentation model. Specifically, an optimal segmentation path is searched by using an efficient searching algorithm. In the searching process, a score of each candidate segmentation path is calculated, and this process is similar to the process of Chinese word segmentation. Specifically, for example, the optimal segmentation path is searched by using a Viterbi algorithm. The detail description of the Viterbi algorithm can be seen in the article “Error Bounds for Convolutional Codes and An Asymptotically Optimum Decoding Algorithm” written by A. J. Viterbi, 1967, IEEE Trans. On Information Theory, 13(2), p. 260-269 (referred to article 3 hereafter), all of which are incorporated herein by reference.

Moreover, the segmentation unit 605 of the embodiment further includes an optimal segmentation path selecting unit configured to select a candidate segmentation path with a highest score as an optimal segmentation path. As shown in FIG. 4, the following segmentation path is selected as the optimal segmentation path:

That's very kind of you ∥ but I don't think I will I'm driving. ∥

Return to FIG. 6, after the long sentence in the text recognized by the speech recognition unit 601 is segmented by the segmentation unit 605 into a plurality of simple sentences, each of said plurality of simple sentences is translated by the translation unit 610 into a sentence of a target language. For example, for the above sentence, the following two sentence are needed to be translated respectively:

That's very kind of you ∥

But I don't think I will I'm driving. ∥

In the embodiment, any machine translation apparatus such as rule-based translation, example-based translation and statistical translation can be used as the translation unit 610 to translate the above simple sentences. Specifically, for example, the machine translation apparatus disclosed in the above article 2 can be used as the translation unit 610 to translate the above simple sentences, and the present invention has no limitation on this as long as the segmented simple sentences can be translated into sentences of a target language.

Moreover, optionally, the apparatus 600 for translating a speech of the embodiment further includes a modifying unit 607 configured to allow a user to modify the segmentation result of the segmentation unit 605 after the long sentence in the text recognized by the speech recognition unit 601 is segmented by the segmentation unit 605 into a plurality of simple sentences. The modifying process of the modifying unit 607 of the embodiment will be described in detail by reference of FIG. 5 in follows.

FIG. 5 is a detail schematic view showing a process of the modifying unit 607. As shown in FIG. 5, if there is an error in the segmentation result of the modifying unit 607, the user can modify the error by a click by using the modifying unit 607. For example, there is an error in the following sentence segmented in the segmentation result:

But I don't think I will I'm driving. ∥

which is composed of the following two simple sentences:

But I don't think I will.

I'm driving.

Therefore, the user can click a non-recognized segmentation position, that is to click between “will” and “I'm” by using the modifying unit 607. Since the position clicked by the user is not a sentence boundary, the position is used as a sentence boundary to segment the sentence. Moreover, if the user clicks a wrong-recognized segmentation position, that is to click a sentence boundary, the sentence boundary is deleted. For example, in the following automatic segmentation result:

We also serve ∥

Tsing Tao Beer here

there is a redundant sentence boundary, therefore there is an error in the segmentation result. At this point, the user can click the redundant sentence boundary to delete the sentence boundary.

Through the modifying of the modifying unit 607, the user can modify the segmentation result obtained automatically by the segmentation unit 605 conveniently.

Moreover, optionally, the apparatus 600 for translating a speech of the embodiment further includes a model updating unit configured to update the segmentation model M1 by using the modifying operation performed by the modifying unit 607 as guide information.

Specifically, as shown in FIG. 5, if a sentence boundary “∥” is added between “will” and “I'm” by the modifying unit 607, probabilities of new n-grams generated by the modifying operation of the user is increased, and probabilities of n-grams deleted by the modifying operation of the user is decreased by the model updating unit.

For example, in FIG. 5, if a sentence boundary “∥” is added between “will” and “I'm” by the modifying unit 607, probabilities of the following new n-grams generated by the modifying operation of the user is increased by the model updating unit:

Pr(∥ | will, I)+=67 , that is to increase the probability of segmenting a sentence after “I will”;

Pr(I'm | ∥, will)+=δ, that is to increase the probability of segmenting a sentence between “will” and “I'm”;

Pr(driving | I'm, ∥)+=δ, that is to increase the probability of segmenting a sentence before “I'm driving”.

On the other hand, probabilities of the following n-grams deleted by the modifying operation of the user is decreased by the model updating unit:

Pr(I'm | will, I)−=δ, that is to decrease the probability of following “I'm” after “I will”;

Pr(driving | I'm, will)−=δ, that is to decrease the probability of following “driving” after “will” and “I'm”.

Further, if the sentence boundary “∥” is deleted between “serve” and “Tsing” by the modifying unit 607, probabilities of the following new n-grams generated by the modifying operation of the user is increased by the model updating unit:

Pr(Tsing | serve, also)+=δ, that is to increase the probability of following “Tsing” after “also server”;

Pr(Tao | Tsing, serve)+=δ, that is to increase the probability of following “Tao” after “server” and “Tsing”.

On the other hand, probabilities of the following n-grams deleted by the modifying operation of the user is decreased by the model updating unit:

Pr(∥ | serve, also)−=δ, that is to decrease the probability of segmenting a sentence after “also serve”;

Pr(Tsing | ∥, serve)−=δ, that is to decrease the probability of segmenting a sentence between “serve” and “Tsing”;

Pr(Tao | Tsing, ∥)−=δ, that is to decrease the probability of segmenting a sentence before “Tsing Tao”.

Through the above description, a long sentence segmentation unit is inserted between the speech recognition unit and the machine translation unit in the apparatus 600 for translating a speech of the embodiment, wherein the long sentence in the text recognized can be split into several simple and complete sentences. In this way, difficulties in translation are relieved, and translation quality is improved.

Further, in order to avoid errors in the automatic segmentation result, there is provided a user interface in the apparatus 600 for translating a speech, which allows the user to modify the segmentation results conveniently. In the same time, there is also provided the model updating unit in the apparatus 600 for translating a speech, which is configured to record the modifying operations of the user to update the segmentation model online to adapt the personal requirements of the user. The quality of the automatic segmentation can be improved step by step by using the apparatus 600 for translating a speech for a long run, the possibility of error occurrences in the automatic segmentation can be reduced, and the intervention of the user will be less and less.

Though the method and the apparatus for translating a speech have been described in details with some exemplary embodiments, these above embodiments are not exhaustive. Those skilled in the art may make various variations and modifications within the spirit and scope of the present invention. Therefore, the present invention is not limited to these embodiments; rather, the scope of the present invention is only defined by the appended claims.

What is claimed is:

1. A method for translating a speech, comprising:
recognizing said speech into a text which includes at least one long sentence containing a plurality of simple sentences;
segmenting said at least one long sentence into a plurality of simple sentences; and
translating each of said plurality of simple sentences segmented into a sentence of a target language.

2. The method for translating a speech according to claim 1, wherein the step of segmenting said at least one long sentence into a plurality of simple sentences comprises:
segmenting said at least one long sentence into a plurality of simple sentences by using a segmentation model.

3. The method for translating a speech according to claim 2, wherein the step of segmenting said at least one long sentence into a plurality of simple sentences by using a segmentation model comprises:
generating a plurality of candidate segmentation paths for said at least one long sentence;
calculating a score of each of said plurality of candidate segmentation paths by using said segmentation model; and
selecting a candidate segmentation path with a highest score as an optimal segmentation path.

4. The method for translating a speech according to claim 2 or 3, wherein said segmentation model comprises a plurality of n-grams and their probabilities.

5. The method for translating a speech according to claim 1, further comprising:
modifying a segmented result of the step of segmenting said at least one long sentence into a plurality of simple sentences.

6. The method for translating a speech according to claim 5, wherein the step of modifying the segmented result of segmenting said at least one long sentence into a plurality of simple sentences comprises:
adding or deleting a segmentation position into or from said segmented result.

7. The method for translating a speech according to claim 5 or 6, further comprising:
updating said segmentation model based on the segmented result modified.

8. The method for translating a speech according to claim 7, wherein the step of updating said segmentation model based on the segmented result modified comprises:
increasing a probability of an n-gram added by the step of modifying.

9. The method for translating a speech according to claim 7, wherein the step of updating said segmentation model based on the segmented result modified comprises:
decreasing a probability of an n-gram deleted by the step of modifying.

10. An apparatus for translating a speech, comprising:
a speech recognition unit configured to recognize said speech into a text which includes at least one long sentence containing a plurality of simple sentences;
a segmentation unit configured to segment said at least one long sentence into a plurality of simple sentences; and
a translation unit configured to translate each of said plurality of simple sentences segmented by said segmentation unit into a sentence of a target language.

11. The apparatus for translating a speech according to claim 10, wherein said segmentation unit is configured to:
segment said at least one long sentence into a plurality of simple sentences by using a segmentation model.

12. The apparatus for translating a speech according to claim 11, wherein said segmentation unit comprises:
a candidate segmentation path generating unit configured to generate a plurality of candidate segmentation paths for said at least one long sentence;
a score calculating unit configured to calculate a score of each of said plurality of candidate segmentation paths by using said segmentation model; and
an optimal segmentation path selecting unit configured to select a candidate segmentation path with a highest score as an optimal segmentation path.

13. The apparatus for translating a speech according to claim 11 or 12, wherein said segmentation model comprises a plurality of n-grams and their probabilities.

14. The apparatus for translating a speech according to claim 10, further comprising:
a modifying unit configured to modify a segmented result of said segmentation unit.

15. The apparatus for translating a speech according to claim 14, wherein said modifying unit is configured to:
add or delete a segmentation position into or from said segmented result.

16. The apparatus for translating a speech according to claim 14, further comprising:
a model updating unit configured to update said segmentation model based on the segmented result modified by said modifying unit.

17. The apparatus for translating a speech according to claim 16, wherein said model updating unit is configured to:
increase a probability of an n-gram added by said modifying unit.

18. The apparatus for translating a speech according to claim 16, wherein said model updating unit is configured to:
decrease a probability of an n-gram deleted by said modifying unit.
